(19) United States
(12) Patent Application Publication
(10) Pub. No.: US 2025/0210720 A1
(43) Pub. Date: Jun. 26, 2025

(54) ELECTROLYTE FOR LITHIUM SECONDARY BATTERIES AND LITHIUM SECONDARY BATTERIES CONTAINING THE SAME

(71) Applicants: Hyundai Motor Company, Seoul (KR); Kia Corporation, Seoul (KR); Pusan National University Industry-University Cooperation Foundation, Busan (KR)

(72) Inventors: Tae Rim LEE, Hwaseong-si (KR); Yoon Sung LEE, Suwon-si (KR); Yong Ho LEE, Incheon (KR); Sung Ho BAN, Hwaseong-si (KR); Jin Hong LEE, Busan (KR); Jae Bin PARK, Busan (KR); Tae Woong LEE, Busan (KR); Pil Gun OH, Busan (KR); Jae Hong CHOI, Busan (KR)

(73) Assignees: Hyundai Motor Company, Seoul (KR); Kia Corporation, Seoul (KR); Pusan National University Industry-University Cooperation Foundation, Busan (KR)

(21) Appl. No.: 18/657,888

(22) Filed: May 8, 2024

(30) Foreign Application Priority Data
Dec. 20, 2023 (KR) 10-2023-0187678

(51) Int. Cl. H01M 10/0569; H01M 10/0525; H01M 10/0568

(52) U.S. Cl. CPC H01M 10/0569; H01M 10/0525; H01M 10/0568; H01M 2300/0034; H01M 2300/0037

(57) ABSTRACT

In an electrolyte for lithium secondary batteries that contains a lithium salt and 4-fluorotoluene (1F-substituted aromatic solvent, 1-FAS) as a lithium-salt-non-dissociable fluorinated ether solvent and a lithium-dissociable ether solvent, the 4-fluorotoluene solvent suppresses the reaction of lithium-dissociable ether with a lithium metal anode and thus exhibits high flame retardancy, excellent ionic conductivity, and superior lifespan characteristics, a method of preparing the same, and a lithium secondary battery including the same.

### CROSS-REFERENCE TO RELATED APPLICATION

The present application claims priority to Korean Patent Application No. 10-2023-0187678, filed on Dec. 20, 2023, the entire contents of which is incorporated herein for all purposes by this reference.

### BACKGROUND OF THE PRESENT DISCLOSURE

### Field of the Present Disclosure

The present disclosure relates to an electrolyte for lithium secondary batteries that contains a lithium salt and 4-fluorotoluene (1F-substituted aromatic solvent, 1-FAS) as a lithium-salt-non-dissociable fluorinated ether solvent and a lithium-dissociable ether solvent, wherein the 4-fluorotoluene solvent suppresses the reaction of lithium-dissociable ether with the lithium metal anode and thus exhibits high flame retardancy, excellent ionic conductivity, and superior lifespan characteristics, a method of preparing the same, and a lithium secondary battery including the same.

### DESCRIPTION OF RELATED ART

Lithium secondary batteries are widely used in portable energy storage devices, electric vehicles and the like due to high energy density, low cost, long cycle life, and safety thereof. The development of lithium secondary batteries with high energy density and long lifespan is attracting great attention.

Such a lithium secondary battery includes as four key elements a cathode, an anode, a separator and an electrolyte. The performance of the lithium secondary battery is determined by the characteristics of materials for these elements. Recently, battery ignition and explosion issues have been obstacles to the growth of the market for mid-to large-sized batteries used in, for example, electric vehicles and ESSs.

In addition, low cost, rapid charging and discharging, and high safety are required for commercialization of electric vehicles, and high performance to improve battery performance and safety are required for electrolyte solvents and additives for lithium ion batteries.

Carbonate, ester, or ether is used singly or in combination as an organic solvent for electrolytes. However, carbonate-based organic solvents are flammable organic substances and cause side reactions with lithium metal and the formation of dendrites, thus resulting in deterioration in battery safety. In addition, carbonate-based organic solvents have a low flash point and high volatility, thus causing combustion with electrode materials when used at high temperatures, rapidly elevating battery temperatures, and eventually causing thermal runaway. Therefore, the development of stable electrolytes may be considered an important factor to improve the energy density of lithium secondary batteries. In particular, there is a need to develop mid-to large-sized lithium secondary batteries for electric vehicles or hybrid vehicles that are usable in various temperature environments while ensuring excellent output/lifespan characteristics.

The information disclosed in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing an electrolyte for lithium secondary batteries that contains a lithium salt and 4-fluorotoluene (1F-substituted aromatic solvent, 1-FAS) as a lithium-salt-non-dissociable fluorinated ether solvent and a lithium-dissociable ether solvent, wherein the 4-fluorotoluene solvent suppresses the reaction of lithium-dissociable ether with the lithium metal anode and thus exhibits high flame retardancy, excellent ionic conductivity, and superior lifespan characteristics, and a lithium secondary battery including the same.

The objects to be solved by the present disclosure are not limited to those mentioned above and other objects not mentioned herein can be clearly understood by those skilled in the art from the following description.

In accordance with an aspect of the present disclosure, the above and other objects can be accomplished by the provision of an electrolyte for lithium secondary batteries containing a non-aqueous organic solvent and a lithium salt, wherein the non-aqueous organic solvent contains 4-fluorotoluene (1F-substituted aromatic solvent, 1-FAS).

In an exemplary embodiment of the present disclosure, a content of 4-fluorotoluene may be 30 to 70 vol % based on 100 vol % of a total volume of the non-aqueous organic solvent.

In an exemplary embodiment of the present disclosure, the non-aqueous organic solvent may further contain dimethoxyethane.

In an exemplary embodiment of the present disclosure, a volume ratio of the 4-fluorotoluene and the dimethoxyethane contained in the non-aqueous organic solvent may be 1:0.5 to 1:2.

In an exemplary embodiment of the present disclosure, the lithium salt may be selected from the group consisting of LiPF₆, LiTFSI, LiDFOB, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N (LiFSI), (CF₃SO₂)₂Nli and mixtures thereof.

In an exemplary embodiment of the present disclosure, the lithium salt may be contained at a concentration of 0.9 to 1.5M in the electrolyte.

In accordance with another aspect of the present disclosure, there is provided a method of preparing an electrolyte for lithium secondary batteries including preparing a non-aqueous organic solvent and adding a lithium salt to the non-aqueous organic solvent, wherein the non-aqueous organic solvent contains 4-fluorotoluene (1F-substituted aromatic solvent, 1-FAS).

In an exemplary embodiment of the present disclosure, a content of 4-fluorotoluene may be 30 to 70 vol % based on 100 vol % of a total volume of the non-aqueous organic solvent.

In an exemplary embodiment of the present disclosure, the non-aqueous organic solvent may further contain dimethoxyethane.

In an exemplary embodiment of the present disclosure, in the step of preparing the non-aqueous organic solvent, a volume ratio of the 4-fluorotoluene and the dimethoxyethane contained in the non-aqueous organic solvent may be 1:0.5 to 1:2.

In an exemplary embodiment of the present disclosure, the lithium salt may be selected from the group consisting of LiPF₆, LiTFSI, LiDFOB, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N (LiFSI), (CF₃SO₂)₂Nli and mixtures thereof.

In an exemplary embodiment of the present disclosure, in the step of adding the lithium salt, the lithium salt may be added at a concentration of 0.9 to 1.5M with respect to the electrolyte.

In accordance with another aspect of the present disclosure, there is provided a lithium secondary battery including the electrolyte according to an exemplary embodiment of the present disclosure, a cathode, and an anode.

In an exemplary embodiment of the present disclosure, the cathode may contain LiNiₓMn_{y}CO_{1-x-y}O₂ (0≤x≤0.9).

In an exemplary embodiment of the present disclosure, the anode may contain graphite and silicon (Si), wherein a content of the silicon is 1 to 20 wt % based on a total of 100 wt % of the anode.

The methods of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a structural formula of 4-fluorotoluene (1F-substituted aromatic solvent, 1-FAS) contained in a non-aqueous organic solvent of an electrolyte for a lithium secondary battery of the present disclosure;

FIG. 2 is a structural formula of dimethoxyethane contained in the non-aqueous organic solvent of the electrolyte for a lithium secondary battery of the present disclosure;

FIG. 3 illustrates a method of preparing an electrolyte for a lithium secondary battery of the present disclosure;

FIG. 4 is a graph showing comparison in capacity retention (%) as a function of charge/discharge cycle between Example 12 and Comparative Examples 1 and 3; and

FIG. 5 is a graph showing comparison in discharge capacity as functions of charge/discharge cycle and rate between Example 12 and Comparative Example 3.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Reference will now be made in detail to the exemplary embodiments of the present disclosure, examples of which are illustrated in the accompanying drawings.

However, the present disclosure is not limited to the embodiments and will be embodied in different forms. Those skilled in the art will appreciate that various modifications, additions and substitutions are possible, without departing from the scope and spirit of the present disclosure as disclosed in the accompanying claims.

It will be understood that the terms may be used herein only to illustrate specific embodiments and should not be construed as limiting the scope of the present disclosure. Singular forms are intended to include plural forms as well, unless the context clearly indicates otherwise. It will be further understood that the terms “comprises”, “has” and the like, when used in the present specification, specify the presence of stated features, numbers, steps, operations, elements, components or combinations thereof, but do not preclude the presence or addition of one or more other features, numbers, steps, operations, elements, components, or combinations thereof.

It should be understood that, in the specification, a range of “X to Y” includes all integers between X and Y. In addition, for example, the range of “1 to 10” includes, in addition to 1 and 10, all numbers, namely, integers and decimal numbers, between 1 and 10.

Unless defined otherwise, all terms used herein including technical or scientific terms have the same meanings as generally understood by those skilled in the art to which the present disclosure pertains. In addition, terms identical to those defined in generally used dictionaries should be interpreted as having meanings identical to contextual meanings of the related art, and are not interpreted as having ideal or excessively formal meanings unless they are definitely defined in the present specification.

The present disclosure relates to an electrolyte for lithium secondary batteries that contains a lithium salt and 4-fluorotoluene (1F-substituted aromatic solvent, 1-FAS) as a lithium-salt-non-dissociable fluorinated ether solvent and a lithium-dissociable ether solvent, wherein the 4-fluorotoluene solvent suppresses the reaction of lithium-dissociable ether with the lithium metal anode and thus exhibits high flame retardancy, excellent ionic conductivity, and superior lifespan characteristics, a method of preparing the same, and a lithium secondary battery including the same.

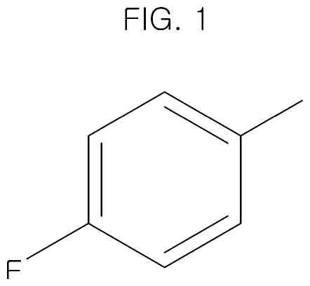

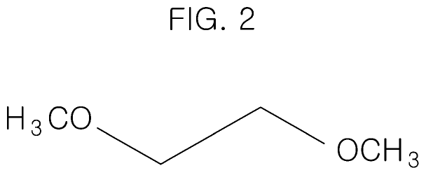

FIG. 1 is a structural formula of 4-fluorotoluene (1F-substituted aromatic solvent, 1-FAS) contained in a non-aqueous organic solvent of an electrolyte for a lithium secondary battery of the present disclosure and FIG. 2 is a structural formula of dimethoxyethane contained in the non-aqueous organic solvent of the electrolyte for a lithium secondary battery of the present disclosure. The electrolyte for lithium secondary battery of the present disclosure will be described with reference to FIG. 1 and FIG. 2.

The electrolyte for a lithium secondary battery of the present disclosure contains a non-aqueous organic solvent and a lithium salt.

In the instant case, the non-aqueous organic solvent serves as a medium through which ions involved in the electrochemical reaction of the battery move. Any one may be used as the non-aqueous organic solvent without limitation as long as it can minimize decomposition due to oxidation reactions during the charging and discharging process of secondary batteries and can exhibit the desired properties along with additives.

The non-aqueous organic solvent may be a carbonate-, ester-, ether-, ketone-, or alcohol-based solvent, or an aprotic solvent, or in combination thereof.

Specifically, the non-aqueous organic solvent of the present disclosure may contain 4-fluorotoluene (1F-substituted aromatic solvent, 1-FAS).

In the instant case, 4-fluorotoluene may be a compound having the structural formula shown in FIG. 1.

The content of 4-fluorotoluene may be 30 vol % or more (excluding 100 wt %), preferably 30 to 70 vol % based on a total of 100 vol % of the non-aqueous organic solvent.

This enables the electrolyte for lithium secondary batteries satisfying the range defined above to exhibit excellent ionic conductivity, flame retardancy, improved long-term life characteristics, and reduced cell resistance, as can be seen from the examples given later.

In addition, the non-aqueous organic solvent may further contain dimethoxyethane.

In the instant case, the dimethoxyethane may be a compound having the structural formula shown in FIG. 2.

The weight ratio of 4-fluorotoluene and dimethoxyethane contained in the non-aqueous organic solvent may be 1:0.5 to 1:2.

This enables the electrolyte for lithium secondary batteries satisfying the range defined above to exhibit excellent ionic conductivity, flame retardancy, improved long-term life characteristics, and reduced cell resistance, as can be seen from the examples given later.

Meanwhile, the lithium salt constituting the electrolyte for lithium secondary batteries of the present disclosure is selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N (LiFSI), (CF₃SO₂)₂NLi and mixtures thereof.

This enables the electrolyte for lithium secondary batteries of the present disclosure to exhibit excellent ionic conductivity, flame retardancy, improved long-term life characteristics, and reduced cell resistance even for various types of lithium salts.

In the instant case, the lithium salt may be present at a concentration of 0.9 to 1.5 M in the electrolyte. This is because that when the concentration of the lithium salt is less than 0.9M, the conductivity of the electrolyte may decrease and the performance of the electrolyte may deteriorate, and when the concentration of the lithium salt is higher than 1.5M, the viscosity of the electrolyte may increase, the mobility of lithium ions may be reduced, the wettability of the electrolyte may be deteriorated and thus the lithium salt may precipitate rather than being dissolved in the solvent.

Meanwhile, the electrolyte of the present disclosure may, if necessary, further contain an additive for forming an SEI film to improve battery lifespan.

The additive for forming an SEI film that can be used in the present disclosure may be vinylene carbonate (VC), vinylethylene carbonate, fluoroethylene carbonate (FEC), vinylethylene carbonate, cyclic sulfite, saturated sultone, unsaturated sultone, acyclic sulfone, or a mixture thereof.

The additive for forming an SEI film may be present in an amount of 0.5 to 10 wt % based on total wt % of the electrolyte to form an excellent coating film.

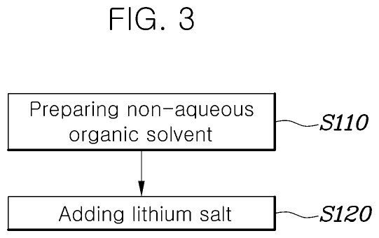

FIG. 3 illustrates a method of preparing an electrolyte for a lithium secondary battery of the present disclosure. The method of preparing an electrolyte for a lithium secondary battery of the present disclosure will be described with reference to FIG. 3.

The method of preparing an electrolyte for a lithium secondary battery of the present disclosure may include preparing a non-aqueous organic solvent (S110).

In the instant case, the non-aqueous organic solvent may contain 4-fluorotoluene (1F-substituted aromatic solvent, 1-FAS).

In the instant case, 4-fluorotoluene may be a compound having the structural formula shown in FIG. 1.

The content of 4-fluorotoluene may be 30 vol % or more (excluding 100 wt %), preferably 30 to 70 vol % based on a total of 100 vol % of the non-aqueous organic solvent.

This enables the electrolyte for lithium secondary batteries satisfying the range defined above to exhibit excellent ionic conductivity, flame retardancy, improved long-term life characteristics, and reduced cell resistance, as described above.

In addition, the non-aqueous organic solvent may further contain dimethoxyethane.

The weight ratio of 4-fluorotoluene and dimethoxyethane contained in the non-aqueous organic solvent may be 1:0.5 to 1:2. This enables the electrolyte for lithium secondary batteries satisfying the range defined above to exhibit excellent ionic conductivity, flame retardancy, improved long-term life characteristics, and reduced cell resistance, as described above.

In addition, the method of preparing an electrolyte for a lithium secondary battery of the present disclosure may include adding a lithium salt to the non-aqueous organic solvent (S120).

In the instant case, the lithium salt may be selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N (LiFSI), (CF₃SO₂)₂NLi and mixtures thereof.

In addition, the lithium salt may be present in the electrolyte at a concentration of 0.9 to 1.5 M. This is because that when the concentration of the lithium salt is less than 0.9M based on the electrolyte, the conductivity of the electrolyte may decrease and the performance of the electrolyte may deteriorate, and when the concentration of the lithium salt is higher than 1.5M, the viscosity of the electrolyte may increase, the mobility of lithium ions may be reduced, the wettability of the electrolyte may be deteriorated and thus the lithium salt may precipitate rather than being dissolved in the solvent.

Another exemplary embodiment of the present disclosure provides a lithium secondary battery including a cathode including a cathode active material, an anode containing an anode active material, and the electrolyte according to an exemplary embodiment of the present disclosure.

Specifically, the lithium secondary battery of the present disclosure may be manufactured by injecting the electrolyte for a lithium secondary battery of the present disclosure into an electrode structure including a cathode, an anode, and a separator interposed between the cathode and the anode. In this case, the cathode, the anode and the separator constituting the electrode structure may be the same as those commonly used to manufacture lithium secondary batteries.

### <Cathode>

A cathode active material may be prepared using a material containing a compound capable of reversible lithiation and de-lithiation of lithium.

Specifically, the cathode active material may include a lithium composite metal oxide containing lithium and at least one metal such as cobalt, manganese, nickel, or aluminum.

More specifically, examples of the lithium composite metal oxide include lithium-manganese-based oxides (e.g., LiMnO₂, LiMn₂O₄, or the like), lithium-cobalt-based oxides (e.g., LiCoO₂, or the like), lithium-nickel-based oxides (e.g., LiNiO₂, or the like), lithium-nickel-manganese-based oxides (e.g., LiNi_{1-y}Mn_{y}O₂ (wherein 0<Y<1, or the like), lithium-nickel-manganese-cobalt-based oxides (e.g., Li(NiₚCo_{q}Mnᵣ₁) O₂ (wherein 0<p<1, 0<q<1, and 0<r1<1, with the proviso of p+q+r1=1) or Li(Niₚ₁Co_{q1}Mnᵣ₂)O₄ (wherein 0<p1<2, 0<q1<2, 0<r2<2, p1+q1+r2=2, or the like), or lithium-nickel-cobalt-transition metal (M) oxide (e.g., Li(Niₚ₂CO_{q2}Mnᵣ₃M_{S2})O₂ (wherein M is selected from the group consisting of Al, Fe, V, Cr, Ti, Ta, Mg and Mo, and p2, q2, r3 and s2 are each atomic fractions of independent elements, wherein 0<p2<1,0<q2<1,0<r3<1,0<s2<1, p2+q2+r3+s2=1), and the lithium composite metal oxide may include any one of these compounds or a combination of two or more.

For example, the cathode may include LiNiₓMn_{y}CO_{1-x-y}O₂ (0≤x≤0.9).

The cathode may be produced by forming a cathode mixture layer on the cathode current collector. The cathode mixture layer may be prepared by coating a cathode current collector with a cathode slurry containing a cathode active material, a binder, a conductive material, and a solvent, followed by drying and rolling.

### <Anode>

The anode active material may also be formed using a material that can de-intercalate lithium ions or cause a conversion reaction.

An anode material may be obtained by mixing an anode active material, a conductive material, and a binder.

Specifically, the anode active material is selected from the group consisting of: lithium-containing titanium complex oxide (LTO); carbon-based materials such as non-graphitized carbon including graphite and graphitic carbon; metal composite oxides such as LiₓFe₂O₃(0≤x≤1), LiₓWO₂(0≤x≤1) and SnₓMe₁₋ₓMe′_{y}O_{z} (Me: Mn, Fe, Pb, Ge; Me′: Al, B, P, Si, elements of Groups 1, 2 and 3 of the periodic table, halogens; 0<x<1; 1<y<3; 1<z<8); a lithium metal; lithium alloys; silicon (Si)-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; and mixtures thereof.

For example, the anode includes graphite and silicon (Si), and the content of silicon may be 1 to 20 wt % based on 100 wt % of the total weight of the anode.

The anode material may be applied onto a cathode current collector to form a cathode. The cathode current collector may be a conductor. The applying the anode material onto the cathode current collector may be performed by preparing a paste using pressure-molding or an organic solvent, applying the paste to the current collector, and pressing to fix the paste thereto.

### <Electrolyte>

The electrolyte may contain lithium. In addition, an electrolyte containing fluorine may be used. In addition, a non-aqueous electrolyte solution in which an electrolyte is dissolved in an organic solvent may be used. Alternatively, a solid electrolyte may be used as well. In addition, the solid electrolyte may act as a separator, which will be described later. In the instant case, a separator may not be required.

### <Separator>

A separator may be interposed between the cathode and the anode. This separator may be a material in the form of a porous film, non-woven fabric, or woven fabric. The thickness of the separator is preferably as thin as possible as long as mechanical strength is maintained because he volumetric energy density of the battery increases and internal resistance decreases.

### <Method of Producing Alkaline Metal Secondary Battery>

A cathode, a separator, and an anode are stacked in this order to form an electrode group, the electrode group is accommodated in a battery can (after being rolled, if necessary), and impregned with a non-aqueous electrolyte to manufacture a secondary battery. Alternatively, a cathode, a solid electrolyte, and an anode are stacked in this order to form an electrode group, the electrode group is accommodated in a battery can (after being rolled, if necessary), and impregnated with a non-aqueous electrolyte to manufacture a secondary battery.

The exterior shape of the lithium secondary battery of the present disclosure is not particularly limited and may be a cylinder, square, pouch or coin using a can.

For example, the lithium secondary battery may include the electrolyte for a lithium secondary battery of the present disclosure, a cathode and an anode.

For example, the cathode may contain LiNiₓMn_{y}CO_{1-x-y}O₂ (0.6≤x≤0.9).

For example, the anode contains graphite and silicon (Si), wherein the content of silicon may be 1 to 20 wt %, based on 100 wt % of the total weight of the anode.

Hereinafter, examples and comparative examples will be described. However, these examples are provided only for better understanding of the present disclosure and should be not construed as limiting the scope of the present disclosure.

### Examples and Comparative Examples

### Example 1

A non-aqueous organic solvent was prepared by adding 0.5 M LiTFSI and 0.5 M lithium difluoro (oxalato) borate (LiDFOB) to dimethoxyethane (DME) as a solvent.

### Example 2

A non-aqueous organic solvent was prepared by adding 0.5 M LiTFSI and 0.5 M lithium difluoro (oxalato) borate (LiDFOB) to 4-fluorotoluene (1F-substituted aromatic solvent, 1-FAS) as a solvent.

### Example 3

A non-aqueous organic solvent was prepared by adding 0.5M LiTFSI and 0.5M lithium difluoro (oxalato) borate (LiDFOB) to a mixed solvent of dimethoxyethane (DME) and 4-fluorotoluene (1-FAS) at a volume ratio of 50:50.

### Example 4

A non-aqueous organic solvent was prepared by adding 0.7M LiTFSI and 0.5M lithium difluoro (oxalato) borate (LiDFOB) to a mixed solvent of dimethoxyethane (DME) and 4-fluorotoluene (1-FAS) at a volume ratio of 50:50.

### Example 5

A non-aqueous organic solvent was prepared by adding 0.9M LiTFSI and 0.5M lithium difluoro (oxalato) borate (LiDFOB) to a mixed solvent of dimethoxyethane (DME) and 4-fluorotoluene (1-FAS) at a volume ratio of 50:50.

### Example 6

A non-aqueous organic solvent was prepared by adding 0.9M LiTFSI and 0.3M lithium difluoro (oxalato) borate (LiDFOB) to a mixed solvent of dimethoxyethane (DME) and 4-fluorotoluene (1-FAS) at a volume ratio of 50:50.

### Example 7

A non-aqueous organic solvent was prepared by adding 1.2M LiTFSI and 0.3M lithium difluoro (oxalato) borate (LiDFOB) to a mixed solvent of dimethoxyethane (DME) and 4-fluorotoluene (1-FAS) at a volume ratio of 50:50.

### Example 8

A non-aqueous organic solvent was prepared by adding 1.5M LiTFSI and 0.5M lithium difluoro (oxalato) borate (LiDFOB) to a mixed solvent of dimethoxyethane (DME) and 4-fluorotoluene (1F-substituted aromatic solvent, 1-FAS) at a volume ratio of 50:50.

### Example 9

A non-aqueous organic solvent was prepared by adding 1.2M LiTFSI and 0.3M lithium difluoro (oxalato) borate (LiDFOB) to a mixed solvent of dimethoxyethane (DME) and 4-fluorotoluene (1F-substituted aromatic solvent, 1-FAS) at a volume ratio of 20:80.

### Example 10

A non-aqueous organic solvent was prepared by adding 1.2M LiTFSI and 0.3M lithium difluoro (oxalato) borate (LiDFOB) to a mixed solvent of dimethoxyethane (DME) and 4-fluorotoluene (1F-substituted aromatic solvent, 1-FAS) at a volume ratio of 30:70.

### Example 11

A non-aqueous organic solvent was prepared by adding 1.2M LiTFSI and 0.3M lithium difluoro (oxalato) borate (LiDFOB) to a mixed solvent of dimethoxyethane (DME) and 4-fluorotoluene (1F-substituted aromatic solvent, 1-FAS) at a volume ratio of 40:60.

### Example 12

A non-aqueous organic solvent was prepared by adding 1.2M LiTFSI and 0.3M lithium difluoro (oxalato) borate (LiDFOB) to a mixed solvent of dimethoxyethane (DME) and 4-fluorotoluene (1F-substituted aromatic solvent, 1-FAS) at a volume ratio of 50:50.

### Example 13

A non-aqueous organic solvent was prepared by adding 1.2M LiTFSI and 0.3M lithium difluoro (oxalato) borate (LiDFOB) to a mixed solvent of dimethoxyethane (DME) and 4-fluorotoluene (1F-substituted aromatic solvent, 1-FAS) at a volume ratio of 60:40.

### Example 14

A non-aqueous organic solvent was prepared by adding 1.2M LiTFSI and 0.3M lithium difluoro (oxalato) borate (LiDFOB) to a mixed solvent of dimethoxyethane (DME) and 4-fluorotoluene (1F-substituted aromatic solvent, 1-FAS) at a volume ratio of 70:30.

### Example 15

A non-aqueous organic solvent was prepared by adding 1.2M LiTFSI and 0.3M lithium difluoro (oxalato) borate (LiDFOB) to a mixed solvent of dimethoxyethane (DME) and 4-fluorotoluene (1F-substituted aromatic solvent, 1-FAS) at a volume ratio of 80:20.

### Comparative Example 1

A non-aqueous organic solvent was prepared by adding 1.0M LiPF₆ to a mixed solvent of ethylene carbonate (EC) and ethylmethyl carbonate (EMC) at a volume ratio of 50:50.

### Comparative Example 2

A non-aqueous organic solvent was prepared by adding 0.5M LiTFSI and 0.5M lithium difluoro (oxalato) borate (LiDFOB) to a mixed solvent of ethylene carbonate (EC) and ethylmethyl carbonate (EMC) at a volume ratio of 50:50.

### Comparative Example 3

A non-aqueous organic solvent was prepared by adding 1.2M LiTFSI and 0.3M lithium difluoro (oxalato) borate (LiDFOB) to a mixed solvent of ethylene carbonate (EC) and ethylmethyl carbonate (EMC) at a volume ratio of 50:50.

### Experiment Example

### <Ionic Conductivity/Phase Separation>

The ionic conductivity and phase separation of the non-aqueous electrolytes of Examples 1 to 8 and Comparative Examples 1 to 2 were measured and the measured values are shown in Table 1 below.

TABLE 1

| | Lithium salt (M) | | | Solvent (%) | | | | Ion conductivity | Phase |
|---|---|---|---|---|---|---|---|---|---|
| | LiPF₆ | LiTFSI | LiDFOB | EC | EMC | DME | 1-FAS | (mS/cm) | separation |
| Comp. | 1.0 | | | 50 | 50 | | | 8.9 | X |
| Ex. 1 | | | | | | | | | |
| Comp. | | 0.5 | 0.5 | 50 | 50 | | | 7.8 | X |
| Ex. 2 | | | | | | | | | |
| Ex. 1 | | 0.5 | 0.5 | | | 100 | | 6.7 | X |
| Ex. 2 | | 0.5 | 0.5 | | | | 100 | 2.8 | ◯ |
| Ex. 3 | | 0.5 | 0.5 | | | 50 | 50 | 6.6 | X |
| Ex. 4 | | 0.7 | 0.5 | | | 50 | 50 | 6.5 | X |
| Ex. 5 | | 0.9 | 0.5 | | | 50 | 50 | 6.4 | X |
| Ex. 6 | | 0.9 | 0.3 | | | 50 | 50 | 6.3 | X |
| Ex. 7 | | 1.2 | 0.3 | | | 50 | 50 | 6.8 | X |
| Ex. 8 | | 1.5 | 0.3 | | | 50 | 50 | 2.9 | ◯ |

The concentration of lithium salt that is added is expressed based on the electrolyte. The content (%) of each solvent is expressed based on 100 vol % of the total volume of the electrolyte.

It can be seen that Examples 1 and 3 to 8 exhibit better ionic conductivity than Comparative Examples 1 and 2.

However, it can be seen that, when 4-fluorotoluene (1F-substituted aromatic solvent, 1-FAS) was 100 vol % of the total volume of the electrolyte as in Example 1, phase separation, that is, precipitation of lithium salt, occurred.

In addition, it can be seen that, when the total lithium salt concentration was 1.5M as in Example 7, phase separation did not occur, whereas when the total lithium salt concentration was 1.8M higher than 1.5M, as in Example 8, phase separation occurred.

### <Test of Flame Retardancy and Lifespan Characteristics>

### Flame Retardancy Test

Each of the electrolytes of Examples 9 to 15 and Comparative Examples 1 and 3 was ignited with a torch and the self-extinguishing time (SET) per weight (g) of the electrolyte was measured after the torch was removed.

SET<6 may be defined as non-flammable, 6<SET<20 may be defined as flame retardant, and 20≤SET may be defined as flammable.

### (2) Manufacturing of Lithium Secondary Batteries

A cathode containing LiNiₓMn_{y}CO_{1-x-y}O₂ (x=0.88, NCM) as a cathode active material, an anode containing 95% graphite and 5% silicon as an anode active material, and a non-aqueous electrolyte according to each of Examples 9 to 15 and Comparative Examples 1 and 3 to manufacture a lithium secondary battery.

### (3) Formation Process and Measurement of Capacity Retention (Life Characteristics)

In a formation process, a cycle including charging at a constant current of 0.1C, charging at a constant voltage of 4.2V while cut-offing at a current of 0.02C, and discharging at a constant current of 0.1C was repeated twice.

Then, to evaluate the lifespan characteristics, the cycle of charging and discharging at a constant current of 1.0C was repeated 100 times.

After 100 charge/discharge cycles of the batteries manufactured using the non-aqueous electrolytes of Examples and Comparative Examples, the capacity retention was calculated using Equation 1 below and the lifespan characteristics were compared based on the capacity retention.

$$Capcacity retention = [ \text{} ( Discharge capacity after 100 charge / discharge cycles ) / ( Discharge capacity after 1 charge / discharge cycle ) ] \qquad [ Equation 1 ]$$

The flame retardancy of Examples 9 to 15 and Comparative Examples 1 and 3 was measured. In addition, discharge capacity after 1 charge/discharge cycle and the discharge capacity after 100 charge/discharge cycles were measured, the capacity retention was measured and the result is shown in Table 1 below.

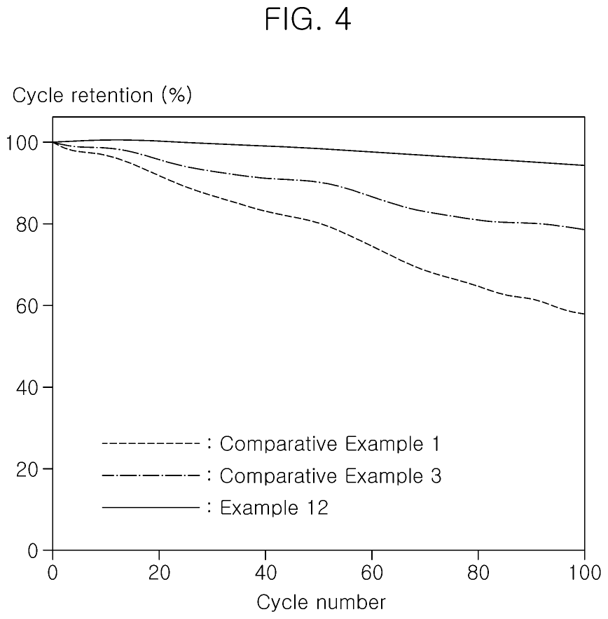

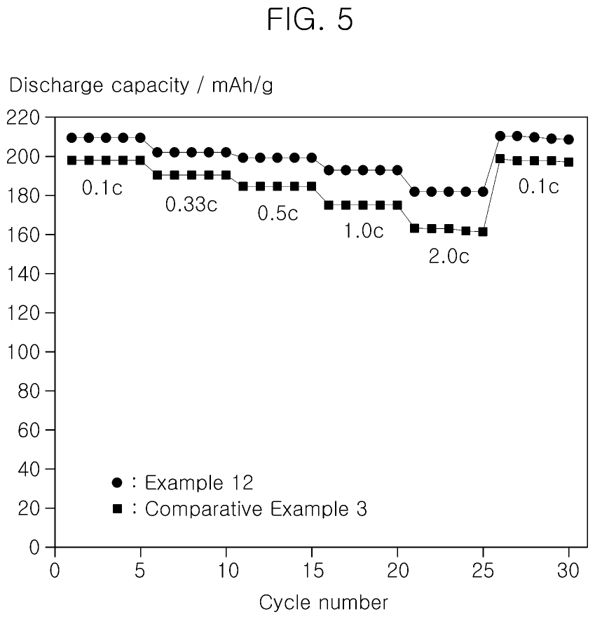

In addition, a graph showing comparison in capacity retention (%) as a function of charge/discharge cycle between Example 12 and Comparative Examples 1 and 3 is shown in FIG. 4 and a graph showing comparison in discharge capacity as functions of charge/discharge cycle and rate between Example 12 and Comparative Example 3 is shown in FIG. 5.

TABLE 2

| | | | | | | | | Ion | Flame | Lifespan characteristics | | |
|---|---|---|---|---|---|---|---|---|---|---|---|---|
| | Lithium salt (M) | | | Solvent (v/v) | | | | conductivity | retardancy | 1 | 100 | Capacity |
| | LiPF₆ | LiTFSI | LiDFOB | EC | EMC | DME | 1-FAS | (mS/cm) | test (sec/g) | cycle | cycles | retention |
| Comp. | 1.0 | | | 50 | 50 | | | 8.90 | 78 | 189.7 | 101.9 | 53.7 |
| Ex. 1 | | | | | | | | | | | | |
| Comp. | | 1.2 | 0.3 | 50 | 50 | | | 8.51 | 75 | 189.7 | 149.6 | 78.8 |
| Ex. 3 | | | | | | | | | | | | |
| Ex. 9 | | 1.2 | 0.3 | | | 20 | 80 | 1.94 | 8 | 175.1 | 143.5 | 81.9 |
| Ex. 10 | | 1.2 | 0.3 | | | 30 | 70 | 2.91 | 19 | 192.5 | 179.6 | 93.3 |
| Ex. 11 | | 1.2 | 0.3 | | | 40 | 60 | 5.06 | 21 | 197.4 | 185.1 | 93.8 |
| Ex. 12 | | 1.2 | 0.3 | | | 50 | 50 | 6.87 | 25 | 193 | 178.5 | 92.5 |
| Ex. 13 | | 1.2 | 0.3 | | | 60 | 40 | 6.92 | 28 | 195.4 | 179.4 | 91.8 |
| Ex. 14 | | 1.2 | 0.3 | | | 70 | 30 | 7.81 | 52 | 196.5 | 180.1 | 91.7 |
| Ex. 15 | | 1.2 | 0.3 | | | 80 | 20 | 7.91 | 71 | 189.1 | 171.3 | 90.6 |

As a result of the flame retardancy test, Comparative Example 1 had a high value of 78 (sec/g) and Comparative Example 2 had a high value of 75 (sec/g), which indicates that Comparative Examples had almost no flame retardancy.

However, Examples 9 to 15 had lower flame retardancy test results than Comparative Examples 1 and 3, which indicates that Examples 9 to 15 had excellent flame retardancy.

Specifically, as the volume ratio of 4-fluorotoluene (1F-substituted aromatic solvent, 1-FAS) based on 100 vol % of the total volume of the electrolyte increases, the flame retardancy test value of the electrolyte decreases and Examples had lower flame retardancy test values than Comparative Examples 1 and 3 in all 4-fluorotoluene (1F-substituted aromatic solvent, 1-FAS) volume ratio sections.

This indicates that 4-fluorotoluene (1F-substituted aromatic solvent, 1-FAS) has excellent flame retardancy.

Meanwhile, the result of measurement of the lifespan characteristics shows that Comparative Example 1 had a low capacity retention of 53.7% and Comparative Example 2 had a low capacity retention of 78.8%.

However, it can be seen that Examples 9 to 15 had higher capacity retention than Comparative Examples 1 and 3, which indicates excellent lifespan characteristics.

Specifically, Examples 9 to 15 had capacity retention of 81% or more at all 4-fluorotoluene (1F-substituted aromatic solvent, 1-FAS) volume ratios and had excellent capacity retention and lifespan characteristics in all 4-fluorotoluene (1F-substituted aromatic solvent, 1-FAS) volume ratio sections compared to Comparative Examples 1 and 3.

This shows that 4-fluorotoluene (1F-substituted aromatic solvent, 1-FAS) has excellent capacity retention and lifespan characteristics.

As apparent from the foregoing, the present disclosure provides an electrolyte for lithium secondary batteries that contains a lithium salt and 4-fluorotoluene (1F-substituted aromatic solvent, 1-FAS) as a lithium-salt-non-dissociable fluorinated ether solvent and a lithium-dissociable ether solvent, wherein the 4-fluorotoluene solvent suppresses the reaction of lithium-dissociable ether with the lithium metal anode and thus exhibits high flame retardancy, excellent ionic conductivity, and superior lifespan characteristics, a method of preparing the same, and a lithium secondary battery including the same.

The effects that can be obtained from the present disclosure are not limited to those mentioned above and other effects not mentioned can be clearly understood by those skilled in the art from the description above.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. An electrolyte for lithium secondary batteries, the electrolyte comprising:
a non-aqueous organic solvent; and
a lithium salt,
wherein the non-aqueous organic solvent comprises 4-fluorotoluene (1F-substituted aromatic solvent, 1-FAS).

2. The electrolyte of claim 1, wherein a content of the 4-fluorotoluene is 30 to 70 vol % based on 100 vol % of a total volume of the non-aqueous organic solvent.

3. The electrolyte of claim 1, wherein the non-aqueous organic solvent further comprises dimethoxyethane.

4. The electrolyte of claim 3, wherein a volume ratio of the 4-fluorotoluene and the dimethoxyethane contained in the non-aqueous organic solvent is 1:0.5 to 1:2.

5. The electrolyte of claim 1, wherein the lithium salt is selected from the group consisting of LiPF₆, LiTFSI, LIDFOB, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N (LiFSI), (CF₃SO₂)₂Nli and mixtures thereof.

6. The electrolyte of claim 1, wherein the lithium salt is contained at a concentration of 0.9 to 1.5M in the electrolyte.

7. A method of preparing an electrolyte for lithium secondary batteries, the method comprising:
preparing a non-aqueous organic solvent; and
adding a lithium salt to the non-aqueous organic solvent,
wherein the non-aqueous organic solvent comprises 4-fluorotoluene (1F-substituted aromatic solvent, 1-FAS).

8. The method of claim 7, wherein a content of the 4-fluorotoluene is 30 to 70 vol % based on 100 vol % of a total volume of the non-aqueous organic solvent.

9. The method of claim 7, wherein the non-aqueous organic solvent further comprises dimethoxyethane.

10. The method of claim 9, wherein, in the step of preparing the non-aqueous organic solvent, a volume ratio of the 4-fluorotoluene and the dimethoxyethane contained in the non-aqueous organic solvent is 1:0.5 to 1:2.

11. The method of claim 7, wherein the lithium salt is selected from the group consisting of LiPF₆, LiTFSI, LiDFOB, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N (LiFSI), (CF₃SO₂)₂Nli and mixtures thereof.

12. The method of claim 7, wherein, in the step of adding the lithium salt, the lithium salt is added at a concentration of 0.9 to 1.5M with respect to the electrolyte.

13. A lithium secondary battery comprising:
the electrolyte of claim 1;
a cathode; and
an anode.

14. The lithium secondary battery of claim 13, wherein the cathode comprises LiNiₓMn_{y}CO_{1-x-y}O₂ (0≤x≤0.9).

15. The lithium secondary battery of claim 13, wherein the anode comprises graphite and silicon (Si),
wherein a content of the silicon is 1 to 20 wt % based on a total of 100 wt % of the anode.
